(19) United States
(12) Patent Application Publication
(10) Pub. No.: US 2014/0189036 A1
(43) Pub. Date: Jul. 3, 2014

(54) OPPORTUNISTIC DELIVERY OF CONTENT TO USER DEVICES WITH RATE ADJUSTMENT BASED ON MONITORED CONDITIONS

(71) Applicant: Alcatel-Lucent USA, Inc., Murray Hill, NJ (US)

(72) Inventors: Randeep S. Bhatia, Green Brook, NJ (US); T.V. Lakshman, Morganville, NJ (US); Arun Netravali, Westfield, NJ (US); Krishan Sabnani, Westfield, NJ (US)

(21) Appl. No.: 13/731,202

(22) Filed: Dec. 31, 2012

(51) Int. Cl. H04L 12/26

(52) U.S. Cl. CPC H04L 43/08
USPC 709/213; 709/224

(57) ABSTRACT

At least one processing device of a communication network is configured to implement a content delivery system. The content delivery system in one embodiment is configured to identify a set of user devices to receive content in a scheduling interval, to initiate delivery of the content to the set of user devices at respective delivery rates for a first portion of the scheduling interval, to monitor conditions associated with delivery of the content to the set of user devices, and to adjust a delivery rate of at least one of the user devices in the set for a second portion of the scheduling interval based at least in part on the monitored conditions. The monitored conditions may comprise, for example, buffer occupancy and channel quality for each of the user devices. The identifying, initiating, monitoring and adjusting are repeated for each of a plurality of additional scheduling intervals.

### FIELD

The present invention relates generally to communication networks, and more particularly to delivery of content within such networks.

### BACKGROUND

In order to facilitate the delivery of streaming video and other types of content, communication networks are typically configured to include network caches. For example, such caches may be deployed at multiple locations distributed throughout a given communication network. The network caches store content that has been previously requested from network servers by user devices, such as computers, mobile phones or other communication devices, and may additionally or alternatively store content that is expected to be requested at high volume by such devices.

Network caching arrangements of this type advantageously allow future requests for the cached content to be served directly from the caches rather than from the servers. This limits the congestion on the servers while also avoiding potentially long delays in transporting content from the servers to the user devices. Cache misses are handled by quickly transferring the requested content from the corresponding server to an appropriate network cache.

A potential drawback of conventional network caching arrangements is that such arrangements are not able to address local impairments that can arise on the access side of the network and adversely impact content streaming to the user devices. These impairments are particularly pronounced on wireless access portions of the network due to a number of factors including the scarcity of air link resources and channel variability due to fading and user device mobility.

Although well-known content streaming protocols such as Progressive Download (PD) streaming and Adaptive Bit Rate (ABR) streaming can dynamically adjust content delivery rates to adapt to varying network conditions, these protocols also have significant drawbacks. For example, such content streaming protocols generally provide no control over the particular network paths that are utilized for streaming of content to user devices. Also, each user device running an instance of one of these content streaming protocols typically makes its own independent decision regarding the content delivery rate to be utilized at a given point in time, which can lead to an inefficient allocation of network resources across multiple user devices.

### SUMMARY

Illustrative embodiments of the present invention provide improved delivery of streaming video and other types of content from network caches to user devices in a communication network. For example, these embodiments provide content delivery techniques that overcome the above-noted drawbacks of conventional network caching and content streaming protocols by opportunistically delivering the content to selected user devices at rates determined based on monitored conditions such as buffer occupancy and channel quality.

In one embodiment, at least one processing device of a communication network is configured to implement a content delivery system. The content delivery system is configured to identify a set of user devices to receive content in a scheduling interval, to initiate delivery of the content to the set of user devices at respective delivery rates for a first portion of the scheduling interval, to monitor conditions associated with delivery of the content to the set of user devices, and to adjust a delivery rate of at least one of the user devices in the set for a second portion of the scheduling interval based at least in part on the monitored conditions. As indicated above, the monitored conditions may comprise, for example, buffer occupancy and channel quality for each of the user devices. The identifying, initiating, monitoring and adjusting are repeated for each of a plurality of additional scheduling intervals.

The content delivery system may additionally be configured to select particular network caches from which the content will be delivered to the set of user devices, to select particular network paths over which the content will be delivered from the selected network caches to the set of user devices, and to control delivery of the content to the user devices from the selected network caches over the selected network paths. The selection of particular network caches and particular network paths may be performed at least in part responsive to the monitored conditions.

By way of example, the above-noted selection of network paths may involve selection of multiple network paths over which the content will be delivered to a given one of the user devices. In such an arrangement, the multiple network paths may be in different access networks, such as a cellular access network and a wireless local area network. The content delivery system may be configured to switch from a first one of the multiple network paths to a second one of the multiple network paths responsive to a change in at least one of the monitored conditions.

### BRIEF DESCRIPTION OF THE DRAWINGS

FIG. 1A shows a communication network comprising a content delivery system in an illustrative embodiment of the invention.

FIGS. 1B and 1C show respective alternative arrangements of the FIG. 1A communication network. FIGS. 1A, 1B and 1C are collectively referred to herein as FIG. 1.

FIG. 2 is a block diagram of a content delivery system implemented in the communication network of FIG. 1.

FIGS. 3-6 show additional exemplary operating configurations of the FIG. 1A communication network in respective embodiments.

FIG. 7 illustrates time-varying channels for respective first and second users in communication networks of the type illustrated in FIG. 1.

FIG. 8 shows a scheduling algorithm that may be implemented in a content delivery system in communication networks of the type illustrated in FIG. 1.

### DETAILED DESCRIPTION

Illustrative embodiments of the invention will be described herein with reference to exemplary communication networks, content delivery systems and associated processing devices. It should be understood, however, that the invention is not limited to use with the particular networks, systems and devices described, but is instead more generally applicable to any network-based content delivery application in which it is desirable to provide improved performance in terms of parameters such as network resource utilization and user experience.

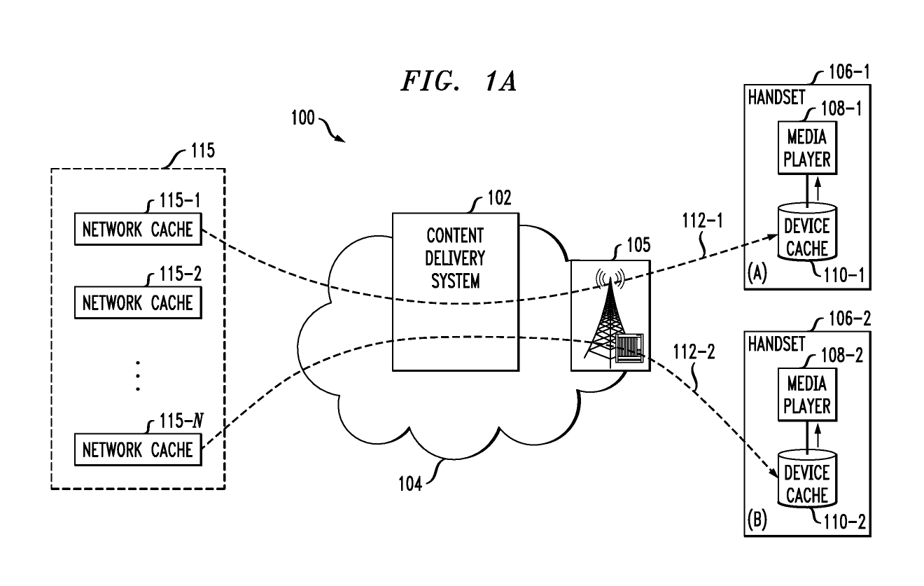

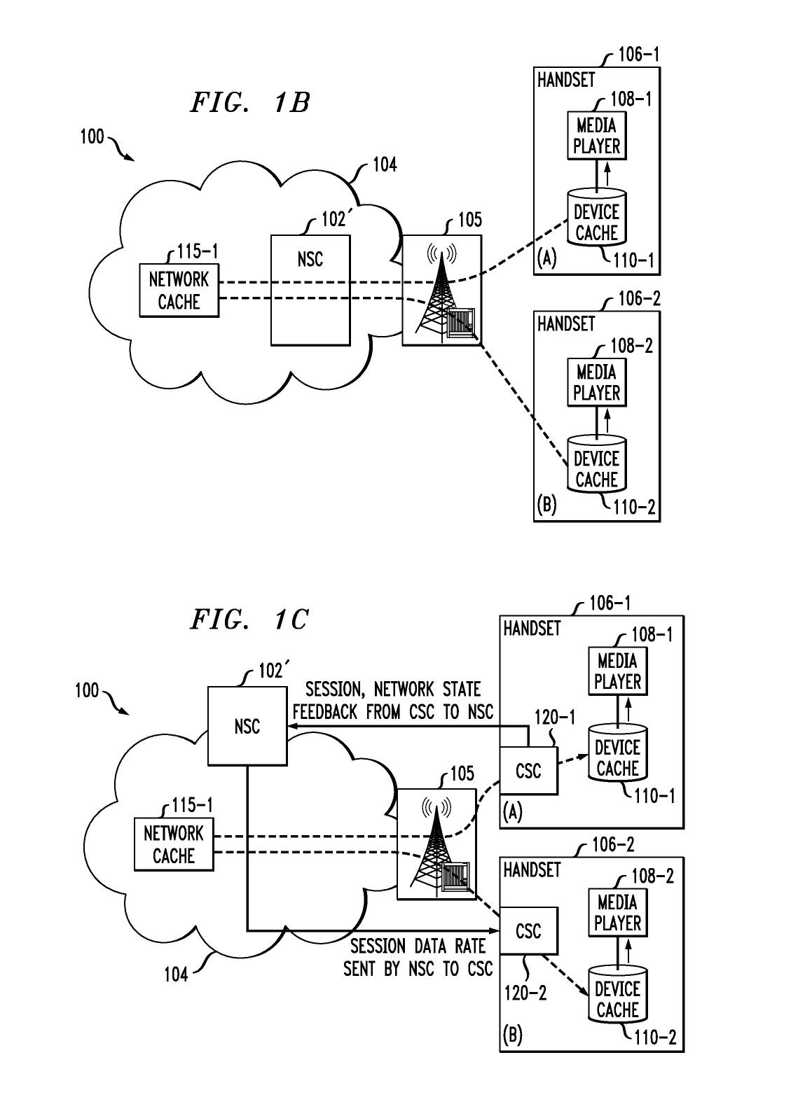

FIG. 1A shows a communication network 100 comprising a content delivery system 102 illustratively associated with an access network 104 that comprises a base station 105. The communication network further comprises a plurality of user devices 106-1 and 106-2 which include respective media players 108-1 and 108-2 coupled to respective device caches 110-1 and 110-2. The device caches 110 are examples of what are more generally referred to herein as “buffers.” Other types of buffers may be used in other embodiments, and such alternative buffers need not comprise caches.

The user devices 106 may comprise, for example, computers, mobile telephones or other communication devices configured to receive content from content delivery system 102 via base station 105. A given such user device 106 will therefore generally comprise a processor and a memory coupled to the processor, as well as a transceiver which allows the user device to communicate with one or more network caches via the base station 105 and access network 104.

Content is delivered under the control of the content delivery system 102 to user devices 106-1 and 106-2 over respective network paths 112-1 and 112-2. The user devices 106 are also denoted herein as respective user devices A and B. In addition, a user device is also referred to herein as simply a “user,” although the latter term in certain contexts herein may additionally or alternatively refer to an actual human user associated with a corresponding device.

It should be noted that “content delivery” as the term is broadly used herein may refer to video streaming as well as other types of content streaming, as well as non-real-time content delivery.

In some embodiment, the user devices 106 are referred to as respective clients, and the content delivery system 102 is associated with one or more servers. However, other embodiments do not require the use of such a client-server model.

The content delivery system 102 controls delivery of content to the user devices 106 from a set 115 of network caches 115-1, 115-2, . . . 115-N. Although shown as separate from the access network 104 in the present embodiment, one or more of the network caches 115 may be implemented at least in part within the access network 104. Alternatively, the network caches 115 may be implemented elsewhere in the communication network 100 so as to be readily accessible to content delivery system 102. In the present embodiment, the content delivery system 102 is coupled between the network caches 115 and the access network 104, although other arrangements are possible.

Although only single instances of content delivery system 102, access network 104 and base station 105 are shown in FIG. 1A, a given embodiment of communication network 100 may include multiple instances of one or more of these elements, as well as additional or alternative arrangements of elements typically found in a conventional implementation of such a communication network.

Also, there may be a significantly larger number of user devices 106 than the two exemplary devices shown in FIG. 1A. Such user devices may be configured in a wide variety of different arrangements. In addition, each such user device may include multiple media players and multiple device caches, although each user device 106 is illustratively shown in FIG. 1A as including only single instances of such elements.

In operation, the content delivery system 102 identifies a set of user devices 106 to receive content in a scheduling interval, initiates delivery of the content to the set of user devices at respective delivery rates for a first portion of the scheduling interval, monitors conditions associated with delivery of the content to the set of user devices, and adjusts a delivery rate of at least one of the user devices in the set for a second portion of the scheduling interval based at least in part on the monitored conditions. These operations are repeated for each of a plurality of additional scheduling intervals. The monitored conditions may comprise, for example, buffer occupancy and channel quality for each of the user devices.

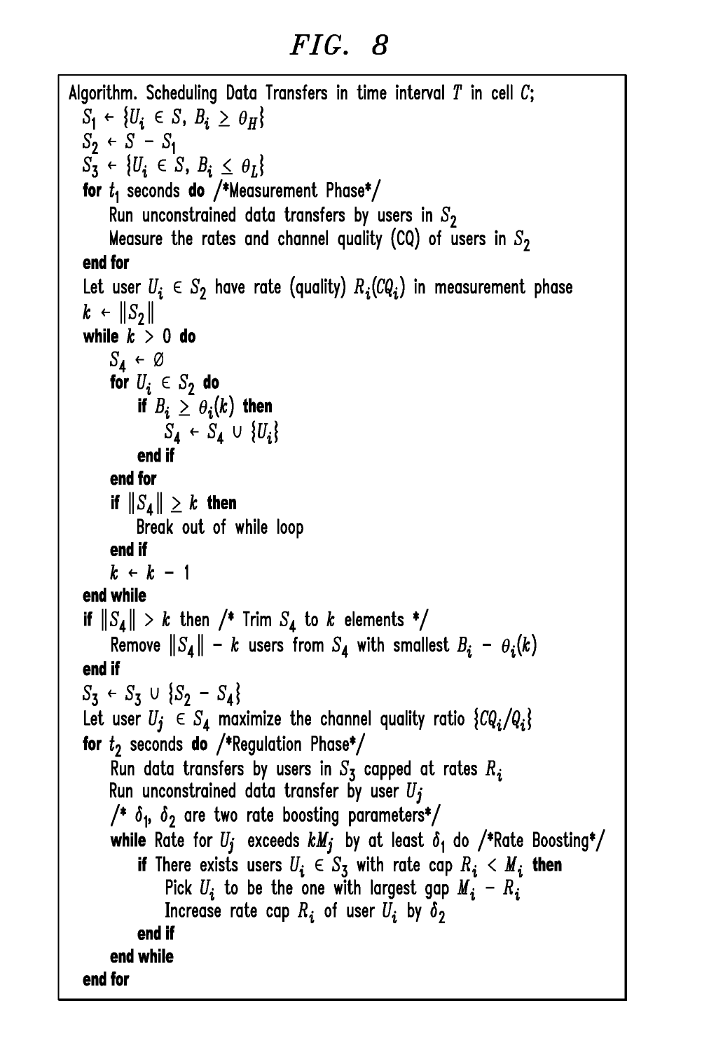

The first and second portions of the scheduling interval may comprise respective measurement and regulation phases of the scheduling interval. A more detailed example of an arrangement of this type will be described in conjunction with the illustrative embodiment of FIG. 8. The scheduling intervals are also referred to in some embodiments herein as time slots.

In identifying a set of user devices to receive content in a scheduling interval, the content delivery system 102 utilizes user device state information such as user device buffer occupancies provided as part of the monitored conditions. Thus, for example, the content delivery system 102 may identify user devices having respective buffer occupancies at or below a low watermark threshold and include those user devices in the set, and identify user devices having respective buffer occupancies at or above a high watermark threshold and exclude those user devices from the set. Those user devices having respective buffer occupancies between the low watermark threshold and the high watermark threshold may also be included in the set.

In adjusting a delivery rate of at least one of the user devices in the set for the second portion of the scheduling interval, the content delivery system 102 identifies at least one of the user devices in the set as having an above average channel quality for the first portion of the scheduling interval based on the monitored conditions. The content delivery system 102 then increases the delivery rate in the second portion of the scheduling interval for that device or devices, while also decreasing the delivery rate in the second portion of the scheduling interval for one or more other user devices in the set that are not identified as having an above average channel quality.

The adjusted delivery rate for a given user device may be an increased delivery rate selected to allow the buffer occupancy of the given user device to reach a specified level within the second portion of the scheduling interval.

Accordingly, the content delivery system 102 in the present embodiment opportunistically delivers content at higher rates to one or more user devices that are currently experiencing above average channel conditions, while reducing the rates for other user devices that may be experiencing below average channel conditions. As will be described in greater detail below, such an arrangement provides significant improvements in network resource utilization and user experience in the communication network 100 relative to conventional techniques.

The scheduling intervals are configured in one or more embodiments to have durations on the order of seconds or minutes, so as to take advantage of slow fading effects in the channels. This is distinct from conventional base station scheduling arrangements in which scheduling intervals are on the order of milliseconds in order to take advantage of fast fading effects in the channels.

Due to slow fading effects, also referred to herein as “shadow” fading, user device channels tend to oscillate slowly between above average channel quality supporting high rates and below average channel quality supporting low delivery rates. Examples of such time-varying channels are illustrated in FIG. 7.

The content delivery system 102 in the present embodiment makes opportunistic use of these slow oscillations in channel quality by identifying in the first portion of a given scheduling interval which user device or devices are currently experiencing above average channel quality, and then increasing delivery rates for that device or devices, while reducing delivery rates for one or more other devices that are currently experiencing below average channel quality. This tends to result in a significant increase in content delivery throughput relative to conventional streaming in which each user device independently determines its delivery rate.

In implementing this opportunistic content delivery process, the content delivery system 102 makes use of the above-noted user state information relating to buffer fullness, which in the present embodiment corresponds to fullness levels of the device caches 110. More particularly, the content delivery system 102 more aggressively fills the device caches 110 at times when their corresponding user devices 106 are experiencing above average channel quality.

In delivering content to a set of user devices determined in the manner described above, the content delivery system 102 also selects particular network caches 115 from which the content will be delivered to the set of user devices, selects particular network paths 112 over which the content will be delivered from the selected network caches 115 to the set of user devices 106, and controls delivery of the content to respective device caches 110 of the set of user devices 106 from the selected network caches 115 over the selected network paths 112.

For example, in the FIG. 1A embodiment, the content delivery system 102 controls delivery of content from network cache 115-1 to device cache 110-1 of user device 106-1 over first network path 112-1, and controls delivery of content from network cache 115-N to device cache 110-2 of user device 106-2 over second network 112-2. The network paths 112 are generally indicated by dashed lines in the figure.

In selecting particular network caches and network paths, the content delivery system 102 utilizes user device state information and network state information, which may be obtained at least in part by monitoring conditions associated with content delivery in the manner previously described. Based on the user device station information and network state information, the content delivery system 102 dynamically selects the best network caches 115 and network paths 112 for delivering content to each of the user devices 106. This process may involve selecting particular user devices 106 to receive content from particular network caches 115 over particular network paths 112. The content delivery system 102 reacts to changing user device and network conditions by updating its selections and the associated content delivery schedule over multiple scheduling intervals.

It should be noted that the content delivery system 102 may select the same network cache for use in delivering content to multiple user devices 106. Thus, for example, a single one of the network caches 115 may be selected to deliver content to user devices 106-1 and 106-2 over respective network paths 112-1 and 112-2.

As indicated above, the content delivery system 102 in the present embodiment selectively assigns content delivery resources among contending user devices 106 based on channel quality measures or other monitored device or network state information relating to those user devices. Accordingly, at particular opportunistic times corresponding to favorable channel conditions for the selected user devices, the content delivery system 102 attempts to fill the device caches 110 of selected user devices 106 with delivered content in order to avoid content “starvation” at other times when their respective channel conditions are less favorable. As indicated previously, such arrangements can provide significant performance gains relative to conventional techniques. For example, by dynamically prioritizing resource allocations to user devices in accordance with their respective channel qualities, much higher network efficiency can be obtained.

The particular configuration of communication network 100 as shown in FIG. 1A is presented by way of illustrative example only, and numerous other arrangements are possible, as will be readily appreciated by those skilled in the art.

For example, in the FIG. 1B embodiment, communication network 100 comprises a content delivery system that is more particularly implemented as a network server component (NSC) 102′. By way of example, the NSC 102′ may be implemented in an otherwise conventional server deployed in or otherwise associated with the access network 104. Also, in this particular embodiment, the NSC 102′ is coupled between a network cache 115-1 implemented within access network 104 and the base station 105. The base station 105 is an example of what is more generally referred to herein as an “access point” of the access network 104. The NSC 102′ is configured to control delivery of content from the network cache 115-1 to device caches 110-1 and 110-2 over respective first and second network paths 112-1 and 112-2.

More particularly, the NSC 102′ in the FIG. 1B embodiment may be configured to have a global view of all content delivery sessions and to regulate the flow of the content from the network caches 115 to the user devices 106. For example, the NSC can track user device and network state information (e.g., buffer occupancy and channel quality) by direct feedback received from the user devices, by indirect feedback received from one or more network elements such as base station 105 or an associated network monitoring tool, or through a combination of these and other techniques.

In the FIG. 1B embodiment, the NSC 102′ is configured as a network proxy to observe content flows between the network cache 115-1 and the user devices 106. This can be implemented in various ways, such as through the use of split TCP sessions, each with one side between a given user device 106 and the NSC and the other side between the NSC and the network cache 115-1.

Another possible arrangement of communication network 100 is shown in FIG. 1C. In this arrangement, the user devices 106-1 include respective client side components (CSCs) 120-1 and 120-2. Also, the NSC 102′ is no longer coupled between the network cache 115-1 and the base station 105. Instead, the NSC 102′ is arranged outside of the first and second network paths 112-1 and 112-2, and receives information such as session and network state feedback from the CSCs 120-1 and 120-2, and provides session data rate information to the CSCs 120-1 and 120-2. It should be noted that the network paths 112 in FIG. 1C pass through the CSCs 120.

The CSCs 120 can monitor conditions such as buffer occupancy, channel quality (e.g., SNR, RSSI), session performance (e.g., throughput, delays, losses) and user device location (e.g., cell ID) and report this information to the NSC 102′. Note that when the CSC is deployed on the user device the NSC would not need to interface with the network elements to obtain additional data about the session (e.g., cell ID) since such information can be provided by the CSC.

It is also possible to implement the previously-described rate adjustments at least in part within the CSC itself by making the data flow to a media streaming application on the user device be proxied via the CSC. In this case, the NSC would not necessarily have to be in the data path but will only be responsible for adaptively selecting the data rates with the actual rate enforcement being implemented by the CSC.

Accordingly, the NSC in such an embodiment would control when each of the CSCs is allowed to download data, by providing appropriate control signals to the respective CSCs. Benefits of utilizing the CSC include better visibility into user device state and network state, and also more scalable distributed rate adjustment enforcement. However, implementation of the CSC within the user device may require changes to existing client side media streaming applications.

Again, the particular embodiments illustrated in FIGS. 1A, 1B and 1C are examples only. The communication network 100 may more generally comprise any type of communication network suitable for delivering content, and the invention is not limited in this regard. For example, portions of the communication network 100 may comprise a wide area network such as the Internet, a metropolitan area network, a local area network, a cable network, a telephone network, a satellite network, as well as portions or combinations of these or other networks. The term “communication network” as used herein is therefore intended to be broadly construed.

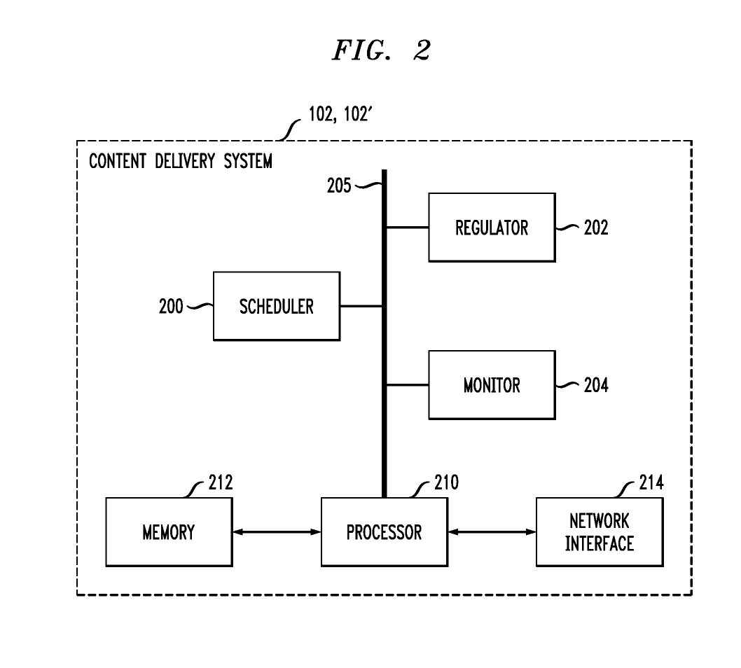

Referring now to FIG. 2, one possible implementation of the content delivery system 102 of the communication network 100 is shown. This implementation may also be viewed as illustrating the NSC 102′ of FIGS. 1B and 1C. In this embodiment, the content delivery system 102 or NSC 102′ comprises a scheduler 200, a regulator 202 and a monitor 204. These elements are coupled to one another via a bus 205 that is also coupled to a processor 210.

The scheduler 200 is configured to identify a set of user devices to receive content in a scheduling interval and to initiate delivery of the content to the set of user devices at respective delivery rates for a first portion of the scheduling interval. The monitor 204 is configured to monitor conditions associated with delivery of the content to the set of user devices, such as buffer occupancy and channel quality. The regulator 202 is configured to adjust a delivery rate of at least one of the user devices in the set for a second portion of the scheduling interval based at least in part on the monitored conditions.

The scheduler 200 in the present embodiment is also configured to select particular network caches 115 from which the content will be delivered to the set of user devices 106, and to select particular network paths 112, such as network paths 112-1 and 112-2 in the FIG. 1 embodiments, over which the content will be delivered from the selected network caches 115 to the set of user devices 106. As indicated previously, the content in these embodiments is delivered to the device caches 110-1 and 110-2 of the respective user devices 106-1 and 106-2 over the respective network paths 112-1 and 112-2.

Again, selection of particular network caches 115 may involve selection of a single network cache to deliver content to multiple user devices 106. Arrangements of this type are illustrated in FIGS. 1B and 1C, where content is delivered from a single network cache 115-1 to user devices 106-1 and 106-2 over respective network paths.

As indicated previously, the selection operations of the scheduler 200 may occur in respective scheduling intervals, also referred to in some embodiments herein as time slots. Thus, for each of a plurality of such scheduling intervals, the scheduler 200 may identify one or more user devices that are experiencing above average channel quality and for which content will therefore be delivered at increased rates.

Content delivery in some embodiments may occur in “sessions” established with respective user devices 106. Thus, in some embodiments, content is delivered to user devices in respective sessions associated with those devices. A given session generally refers to delivery of content to a particular user device.

The scheduler 200 may take into account not only buffer occupancy and channel quality but also other user state information such as buffer drain rate. For example, it can maintain higher rates for those user devices 106 in which their respective device caches 110 are in danger of reaching the above-noted low watermark threshold. This ensures that in addition to high network efficiency, high quality user experience is also maintained for each session.

The regulator 202 adaptively adjusts the rate of data transfer to one or more of the sessions by, for example, slowing down or suspending selected sessions while letting other sessions proceed unconstrained at the highest possible rate. This rate limiting can be implemented in many ways, including slowing down TCP acknowledgements sent from the user devices to the content delivery network.

The above-described functionality of scheduler 200 and regulator 202 are exemplary only, and additional or alternative functionality may be provided in such elements. For example, in other embodiments, the regulator 202 may be eliminated and the rate adjustment functionality may instead be implemented in the scheduler. Also, a scheduler in another embodiment can be configured to use different video resolutions. For example, in some cases different lower resolution videos may be available and besides selecting the data rate for each user the scheduler may also dynamically select the video resolution for improved performance.

Embodiments of the invention are flexible in terms of the scheduling intervals that are used to control content delivery to user devices. However, as indicated above, embodiments of the invention can utilize scheduling intervals on the order of seconds or minutes in order to take advantage of shadow fading. Such arrangements can advantageously complement existing base station scheduling mechanisms that utilize scheduling intervals on the order of milliseconds to take advantage of fast fading.

The monitor 204 is configured to monitor at least one of user device state information and network state information such that selection operations performed by the scheduler 200 are performed at least in part responsive to at least one of the monitored user device state information and the monitored network state information.

One possible example of such monitored information is illustratively shown in FIG. 1C as session and network state feedback provided from CSC 112-1 to NSC 102′. Although not specifically illustrated in FIG. 1C, similar session and network state feedback may be provided from CSC 112-1 to NSC 102′.

The user device state information conveyed from a given user device 106 to content delivery system 102 or NSC 102′ may more particularly comprise information such as buffer occupancy, channel quality and available access networks.

At least a portion of the network state information may be obtained directly by the content delivery system 102 or NSC 102′ from appropriate network elements rather than via feedback from the user devices 106.

The network state information may include information such as access network state information and network cache state information. The access network state information may comprise, for example, information indicative of utilization and congestion of the access network 104 and possibly one or more additional access networks that may be utilized to deliver content to the user devices 106. The network cache state information may comprise, for example, processing load information for each of the network caches 115. Numerous other types of network state information may be used in other embodiments.

Thus, in a given embodiment the monitor 204 may be configured to track the per-session network state including throughput, packet losses and retransmissions as well as the user device state. In addition, the monitor 204 may obtain from base station 105 or other network elements (e.g., an RNC) one or more additional parameters including the cell ID and other location information of the user device. The collected information is used to identify the set of sessions with impaired channel quality and whose data transfer can be curtailed to favor other contending sessions in the same cell that are getting above average channel quality and hence data rate.

As indicated previously, selection operations performed by the scheduler 200 are performed at least in part responsive to at least one of the monitored user device state information and the monitored network state information.

These operations may be carried out so as to ensure that the respective device caches 110 of the selected user devices 106 can be substantially filled to a designated level within a designated amount of time, or to ensure that a designated amount of the content can be delivered to the respective device caches 110 of the selected user devices 106 within a designated amount of time.

For example, selecting in scheduler 200 particular ones of the user devices 106 to receive content at respective delivery rates may involve selecting a subset of the user devices having higher respective ratios of current channel quality to average channel quality relative to other ones of the user devices not in that subset. In other words, the scheduler 200 selects for the current scheduling interval those user devices that have the highest ratios of current channel quality to average channel quality. Other types of channel quality measures or selection criteria may be used in other embodiments.

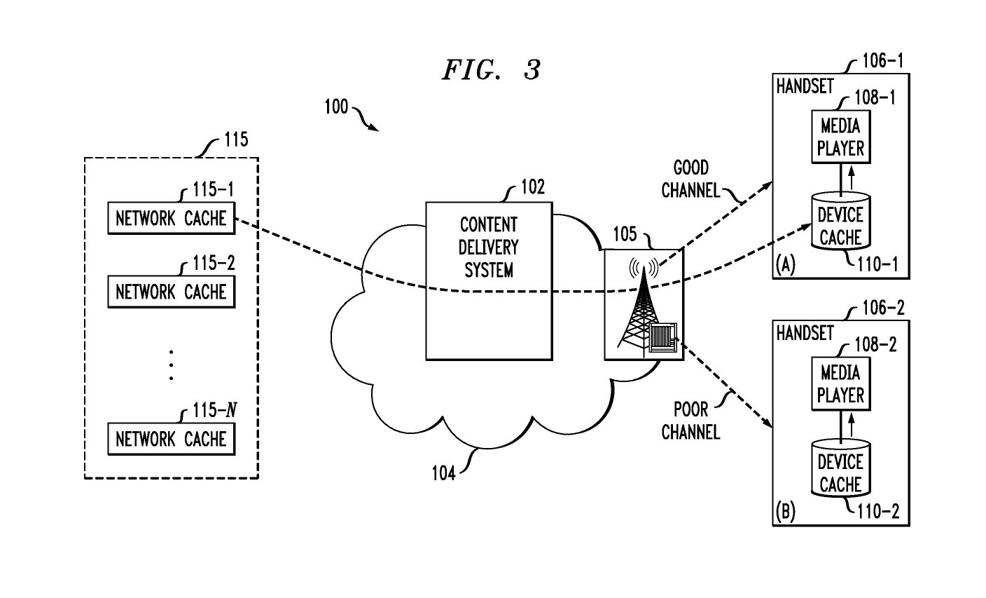

FIG. 3 illustrates an exemplary selection process. Here, the content delivery system 102 has determined based on monitored state information that user device 106-1 currently has a “good” channel with access network 104 via base station 105, while user device 106-2 currently has a “poor” channel with access network 104 via base station 105. In this case, the “good” channel may be assumed to be one that exhibits a current channel quality higher than its average channel quality, and the “poor” channel may be assumed to be one that exhibits a current channel quality lower than its average channel quality. The content delivery system 102 therefore selects user device 106-1 over user device 106-2 and possibly additional user devices not shown, to receive content from network cache 115-1 at a higher rate in a current scheduling interval.

Accordingly, in this embodiment the content delivery system 102 may be viewed as selecting for an increased delivery rate in a current scheduling interval only those user devices that are currently experiencing channel quality above their average channel quality. This helps to ensure the best use of available channel capacity in filling up device caches 110 with delivered content. The particular user devices that are selected to receive content at increased rates based on channel quality measures will typically vary from scheduling interval to scheduling interval, as network conditions change. The content delivery system 102 is therefore able to react to changing network conditions by selecting different user devices, network caches and network paths for content delivery.

For a given user device 106-1 selected for content delivery in a current scheduling interval based on its channel quality as described above, the scheduler 200 may select the network cache 115 having the highest available bandwidth.

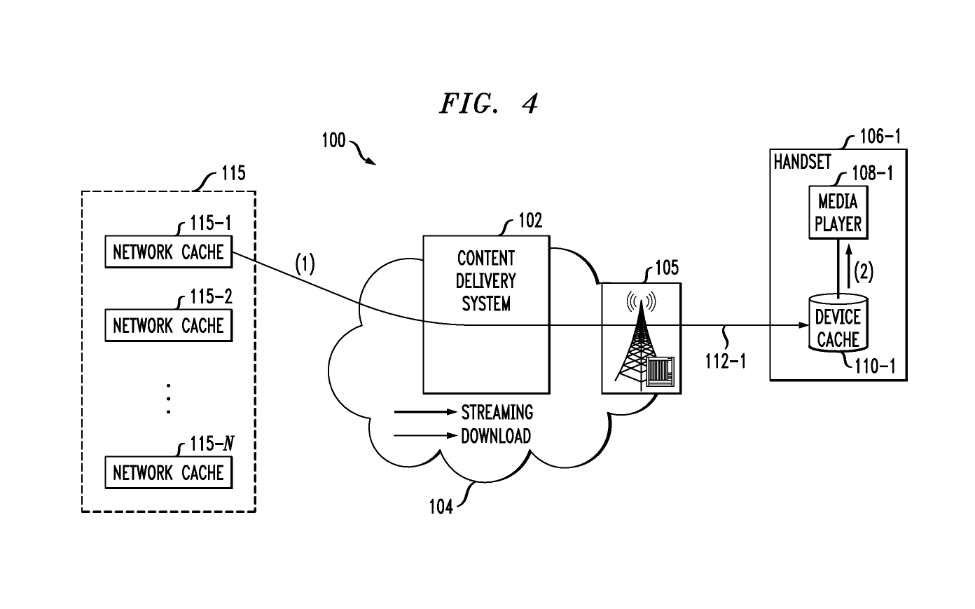

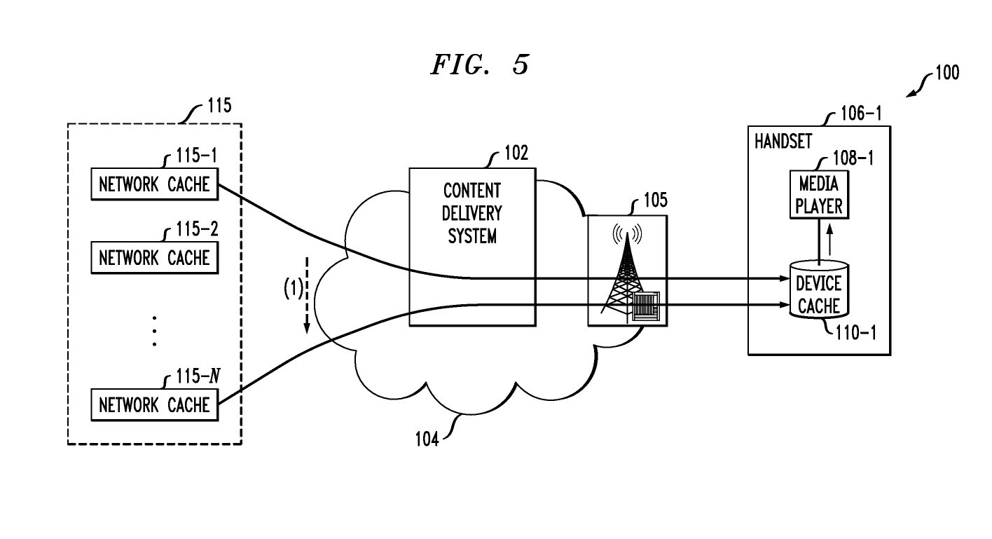

In the embodiment shown in FIG. 4, it is assumed that user device 106-1 has been selected to receive content from network cache 115-1 in a current scheduling interval. The content is initially downloaded from the network cache 115-1 into the device cache 110-1 of the selected user device 106-1 over the best available network path 112-1 at the highest possible rate. This downloading is denoted as line (1) in the figure. The rate may be subsequently increased or decreased based on monitored conditions, as previously described. Content downloaded into the device cache 110-1 is streamed from the device cache to the media player 108-1 as required for playback.

Such an arrangement provides an improved user experience relative to conventional arrangements, independent of short term changes in network state. Also, there is no need for the network to support specialized streaming mechanisms, as the streaming in this embodiment is supported by the device cache 110-1 within the user device 106-1.

As indicated previously, the scheduler 200 selects particular network paths over which content will be delivered from the selected network caches 115 to the set of user devices 106. In some embodiments, this may involve selecting multiple network paths over which the content will be delivered to a given one of the user devices 106. For example, the content delivery system 102 may be configured to switch from a first one of the network paths to a second one of the network paths responsive to a change in at least one designated network condition.

An example of an embodiment of this type is shown in FIG. 5. Again, it is assumed that user device 106-1 has been selected to receive content from one or more network caches 115 in a current scheduling interval. However, in this embodiment, the content delivery system 102 uses multiple network paths to deliver content to the selected user device 106-1. A first selected network path is initially used to deliver content from network cache 115-1 to device cache 110-1 of user device 106-1, while the monitor 204 continues to monitor user device state and network state.

Based on changing network conditions as detected using such monitoring, the content delivery system 102 switches to a second selected network path from network cache 115-N, as illustrated by downward dashed arrow (1) in the figure. The content delivery system 102 therefore adapts to changes in network conditions by switching over to better network caches and network paths during data transfer to the selected user device 106-1. Again, this ensures that content continues to be delivered at an appropriate rate, without adversely impacting user experience.

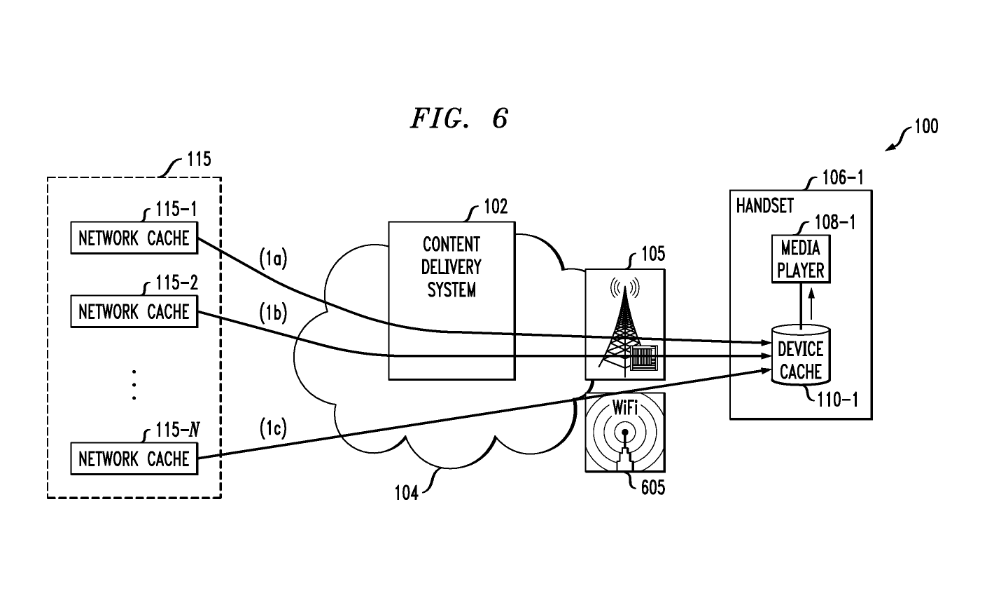

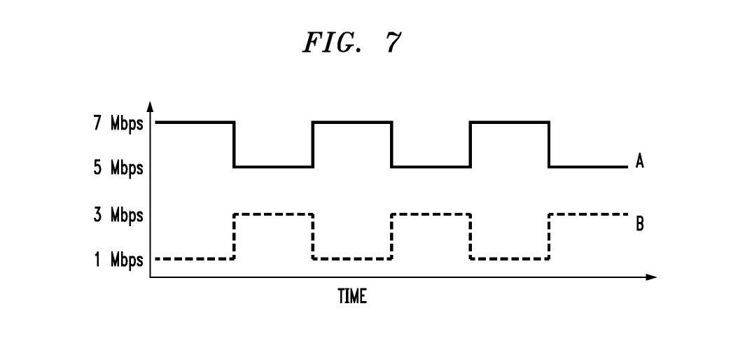

In such an arrangement, for example, the multiple network paths over which the content will be delivered to the given selected user device 106-1 may comprise a first network path through a first access network such as access network 104 and a second network path through a second access network different than the first access network. As one possible illustration, the first and second access networks in such an arrangement may comprise a cellular access network and a wireless local area network, respectively. This is illustrated in the embodiment of FIG. 6, where the multiple network paths include paths (1a) and (1b) from respective selected network caches 115-1 and 115-2 to the selected user device 106-1 via base station 105 associated with access network 104, as well as an addition network path (1c) from network cache 115-N to the selected user device 106-1 via an access point 605 of a different access network, in this case a Wi-Fi network.

Based on monitored user device state information and monitored network state information, the content delivery system 102 switches between these multiple paths, possibly within a given scheduling interval, in delivering content to the device cache 110-1 of the selected user device 106-1. For example, different portions of the content to be delivered can be delivered over different ones of the multiple paths. Alternatively, portions of the content may be delivered simultaneously over two or more of the multiple paths. The portions may be downloaded out of order and at least partially in parallel and combined in the device cache 110-1 for streaming to the media player 108-1. Again, this ensures that the content is delivered at an appropriate rate to the selected user device.

It is to be appreciated that the various delivery arrangements shown in FIGS. 3 through 6 are presented by way of illustrative example only, and numerous other techniques can be used for selecting user devices, network caches and network paths based on monitored information in other embodiments.

Referring again to FIG. 2, the content delivery system 102 or NSC 102′ further comprises a memory 212 and a network interface 214, both coupled to the processor 210.

The processor 210 may be implemented as a microprocessor, a microcontroller, an application-specific integrated circuit (ASIC), field-programmable gate array (FPGA), or other type of processing device, as well as portions or combinations of such devices.

The memory 212 may comprise an electronic random access memory (RAM), a read-only memory (ROM), a disk-based memory, or other type of storage device, as well as portions or combinations of such devices.

The processor 210 and memory 212 may be used in storage and execution of one or more software programs for performance of operations such as scheduling, regulating and monitoring within the content delivery system 102 or NSC 102′. Accordingly, one or more of the scheduler 200, regulator 202 and monitor 204 or portions thereof may be implemented at least in part using such software programs.

The memory 212 may be viewed as an example of what is more generally referred to herein as a computer program product or still more generally as a computer-readable storage medium that has executable program code embodied therein. Other examples of computer-readable storage media may include disks or other types of magnetic or optical media, in any combination. These computer-readable storage media and a wide variety of other articles of manufacture comprising such computer-readable storage media are considered embodiments of the present invention.

The processor 210, memory 212 and network interface 214 may comprise well-known conventional circuitry suitably modified to operate in the manner described herein. Conventional aspects of such circuitry are well known to those skilled in the art and therefore will not be described in detail herein.

It is to be appreciated that an NSC or other type of content delivery system as disclosed herein may be implemented using components and modules other than those specifically shown in the exemplary arrangement of FIG. 2.

In order to illustrate the performance gains possible using communication networks configured as illustrated in FIGS. 1-6, consider two users A and B with time varying channels as illustrated in FIG. 7. In this figure, the solid line represents the channel for user A over time and the dashed line represents the channel for user B over time, both in terms of supported content delivery rate in megabits per second (Mbps). It is assumed that user A is in a better radio geometry than user B and hence has a better average channel quality and a higher corresponding average rate.

Although channel variations for different user are typically uncorrelated, it is assumed in this example that the user A channel is above its average rate whenever the user B channel is below its average rate and vice versa. More particularly, the user A channel toggles between an above average rate of 7 Mbps and a below average rate of 5 Mbps, while the user B channel toggles between an above average rate of 3 Mbps and a below average rate of 1 Mbps.

Thus, if A were the only user to be scheduled, its rate would toggle between 7 and 5 Mbps for an average rate of 6 Mbps. Likewise if B were the only user to be scheduled it would get an average rate of 2 Mbps. However, if both users are active at the same time then they will share the network proportionally resulting in an average rate of (6+2)/2=4 Mbps, with A getting a rate of 6/2=3 Mbps and B getting a rate of 2/2=1 Mbps.

Next assume that users are selected for data transfer based on how much better their channel quality is compared to their average channel quality, in accordance with content delivery techniques disclosed herein. In the current two-user example, this corresponds to selecting that user for data transfer that maximizes the ratio of its current rate to its average rate.

Accordingly, user A will be selected for data transfer in the first time interval, user B will be selected for data transfer in the second time interval, user A will be selected for data transfer in the third time interval, and so on. Thus, only one user is active at any given time and when active user A will get a rate of 7 Mbps and user B will get a rate of 3 Mbps. Since each user will only be active half the time, users A and B will get average rates of 7/2 and 3/2 Mbps respectively for an overall average rate of 7/2+3/2=5 Mbps.

Thus, in the present example, by prioritizing users with above average channel quality for data transfer under the control of content delivery system 102, not only does each user get a higher rate (16.7% higher for A and 50% higher for B) but also the overall throughput of the network is improved (by 25%).

The foregoing is a simple example of an arrangement in which content delivery system 102 dynamically schedules users for data transfer depending on monitored conditions such as channel quality.

This example may be viewed more generally as a type of arrangement in which data transfer for users having temporarily impaired channel quality is curtailed in favor of those users whose channels are currently above their average channel quality. Techniques of this type can be effective even for streaming applications as long as there is high variability in the channels (e.g., due to shadow fading) to ensure that a given user does not stay in below average channel conditions for long periods of time and hence gets scheduled for data transfer often enough to make good progress without adversely impacting the user playback experience.

The content delivery system 102 in these embodiments utilizes the device caches 110 to help deal with playback disruptions that might otherwise occur during periods when data transfer to one or more users is suspended or otherwise performed at a reduced rate due to their below average channel quality. More particularly, opportunistic data transfers by the content delivery system keep the devices caches 110 well replenished. This is because users selected to receive data transfers get high rates, not only due to their above average channel quality, but also due to the fact that they are sharing the available network capacity with fewer other users.

It should be noted that embodiments of the invention can be combined with other mechanisms for buffering large amounts of data to prevent disruptions. For example, user movements in the increasingly common HetNet environment (e.g., an integrated network of LTE, WiFi and small cells) can provide pockets of high capacity areas with very high data rates where fast buffer filling is possible. Pre-loading large portions of the content in advance of playback during off-peak times is also a viable option particularly given the large amounts of client side storage.

An embodiment that prioritizes user devices based on their channel quality and variability should generally not penalize other user devices, particularly those user devices that happen to be located in regions with relatively poor channel quality (e.g., the edge of a cell) or have low channel variability (e.g., static users). Such user devices should continue to receive equal or higher treatment from the network to avoid any deterioration in their user experience, particularly for streaming applications.

This can be accomplished in one or more embodiments of the present invention by additionally incorporating buffer occupancy of the user devices in the scheduling process. For example, as mentioned previously, the content delivery system 102 can be configured such that data transfer for user devices whose buffer occupancy is below a low watermark threshold is not curtailed. As a result, the dynamic prioritizing of data transfer based on channel conditions is only applied to user devices with buffer occupancy above the low watermark threshold. These user devices can deal with disruptions in data transfers during scheduling intervals when they are suspended or otherwise reduced in rate by the scheduler 200.

In addition, some user devices are suspended irrespective of their channel quality once they have built up sufficient buffer occupancy that can continue to play delivered content for some time without needing additional data transfers. Any excess capacity generated either by dynamic prioritization of user devices or by suspending user devices with high buffer occupancy can be made available to user devices with low buffer occupancy to ensure enhanced user experience.

An exemplary scheduling algorithm that may be implemented in content delivery system 102 to provide prioritization of user devices based on buffer occupancy and channel quality will now be described in greater detail, with reference to FIG. 8. It should be understood, however, that a wide variety of other algorithms may be used in other embodiments.

In this exemplary scheduling algorithm, the dynamic scheduling of data transfers is performed once per time slot. The time slot length t is selected to be on the order of tens of seconds. Not considering the impact of fast fading at very short time scales on the order of milliseconds, the channel impairments due to slow fading can be assumed to be relatively static in each time slot as defined above, since a mobile user device can typically only travel a few tens of meters within each time slot, and hence the data rates stay substantially constant within each time slot. In addition, the average channel quality (ACQ), which is related to the distance based constant radio link power loss, can be assumed to be static even for much longer time scales, on the order of tens or even hundreds of time slots, especially since streaming is mainly carried out by semi-static users.

Each scheduling time slot is further sub-divided into two sub-slots of length t₁ and t₂ where t=t₁+t₂. The sub-slot of length t₁ is a measurement phase which precedes a regulation phase corresponding to the sub-slot of length t₂. In the regulation phase, the data transfer for one or more sessions is adjusted based on the buffer occupancy and channel quality of each of the corresponding user devices 106. The buffer occupancy in this context refers to the amount of delivered content stored in the device cache 110 of the corresponding user device.

Consider a cell C and a time slot T. Assume there are n streaming users S={Uᵢ,1≦i≦n} in cell C at this time. We use Qᵢ to denote the ACQ for user i. Let Bᵢ denote the buffer occupancy for user Uᵢ at the beginning of time slot T. Bᵢ is measured in units of time slots of size t. This means that the playback for user Uᵢ can continue for Bᵢ*t seconds from its buffer alone, without any further data transfer. Note that B, depends not only on the number of bytes of data buffered but also on the minimum required streaming rate for user Uᵢ.

Let Mᵢ denote the minimum required streaming rate for user Uᵢ In case of video streaming, Mᵢ is rate at which the video is encoded. Let θᵢ(k) (in units of time slots each t seconds long) denote the buffer occupancy threshold for user Uᵢ for it to be scheduled for dynamic prioritizing of data transfer with k users. Specifically, it means that for Uᵢ to be selected for dynamic prioritization with k−1 other users, its buffer occupancy must be larger than this threshold: Bᵢ≧θᵢ(k). The threshold θᵢ(k) depends on k and additional details regarding computation of the threshold will be provided below.

Let θ_{H}, θ_{L} denote high and low watermark thresholds respectively such that users with buffer occupancy Bᵢ exceeding the high watermark threshold are not scheduled in time slot T while those with buffer occupancy of at most the low watermark threshold are scheduled in time slot T irrespective of their channel conditions. Exemplary values for these thresholds will be provided below.

As indicated previously, the scheduling algorithm in the present example is illustrated in FIG. 8. In this embodiment, the users in set S₁ are not scheduled for data transfer in the current time slot since their buffers already have large occupancy. The users in set S₃ are scheduled for data transfer in this time slot irrespective of their channel quality since their buffer occupancy is critically low. Among the remaining users, in set S₂, the algorithm determines which particular user to schedule in this time slot. It does so in the measurement phase by collecting rate and channel quality information for the users in set S₂ while they do unconstrained data transfers.

Let the rates of these users Uᵢ in the measurement phase be denoted by Rᵢ and their channel qualities be denoted by CQᵢ. Next, the largest set of users S₄⊂S₂ is determined for which data transfer can be dynamically prioritized based on channel conditions. This is done by finding the largest value k (at most the size of S₂) such that there are at least k users Uᵢ in S₂ whose buffer occupancy exceeds their buffer occupancy threshold θᵢ(k) at average data transfer rates Rᵢ. If there are more than k users that satisfy this condition then among them the k best users who have the highest excess buffer occupancy Bᵢ−θᵢ(k) are selected. S₄ then consists of all these k users. All the remaining users in S₂-S₄ are moved to set S₃ to be scheduled for data transfer in this slot. Among the users in S₄ the user Uⱼ with the best current channel quality ratio CQᵢ/Qᵢ (and hence whose rate is highest compared to its average rate) is selected for data transfer in this time slot.

In the regulation phase, all users in S₃ and user Uⱼ are allowed to do data transfer. We start out by capping the rates of the users Uᵢ in S₃ to their measured rates Rᵢ. The user Uⱼ is allowed the rest of the capacity of the cell. At this point, if the rate that Uⱼ is getting far exceeds kMⱼ, then some of this excess capacity is given to the users Uᵢ in S₃ who may not be getting their minimum required rate Mᵢ.

We use two parameters δ₁,δ₂ to control this rate boosting. We always pick the user for rate boosting who is furthest behind in getting its minimum required rate. The rate boosting is done by increasing the rate cap of the user Uᵢ. Note that this will typically trigger a proportional fair mechanism in the cell to try to equalize the bandwidth allocation between users Uⱼ and user Uᵢ thus lowering the rate of user Uⱼ and increasing the rate of user Uᵢ up to its bandwidth cap.

In the regulation phase of the above-described algorithm, the rate of Uⱼ is compared to kMⱼ rather than Mⱼ because even though Rⱼ is the rate user Uⱼ gets in this time slot in the long run its average rate is expected to be only Rⱼ/k. This is because if the set S₄ were not to change over the next few time slots then only one user from the set S₄ will be scheduled in a time slot. This follows from the assumed independence in the channel variations among the users. As a result we can expect Uⱼ to be scheduled in only 1/k-th of the time slots on the average resulting in an average rate of Rⱼ/k. Hence, the rate of Uⱼ in this time slot should be at least kMⱼ so that on average its rate is at least Mⱼ.

The scheduling algorithm of FIG. 8 is configured to deal effectively with the impact of slow fading on channel quality. Typical variations in the radio power received by a mobile user device as a function of time, which also represent the variations of the received data rate since the data rate is directly related to the received signal to noise ratio, include a distance dependent constant path loss, a very fast variation called fast fading and another variation that is spread much more in time and space and is called shadow fading.

The fast fading happens at very short time granularity on the order of milliseconds and is exploited by conventional base station scheduling. However, in order to effectively deal with the shadow fading, the content delivery system 102 in illustrative embodiments is configured to operate at a much coarser time granularity, and may therefore be complementary to conventional base station scheduling. Shadow fading is generally known to have a lognormal distribution with an autocorrelation function that decays exponentially with distance. In particular the correlation between two points x meters apart is given by e^{-αx} where α= 1/20 for environments intermediate between urban and suburban microcellular. Accordingly, the shadow fading function stays substantially stationary for small distances.

The FIG. 8 algorithm therefore performs scheduling once per time slot where each time slot is t seconds long, and the time slot length t is selected to be in the order of tens of seconds. As indicated above, in this time the mobile user device can only travel a few tens of meters and hence the channel quality and data rate, not considering the very fast variations due to fast fading, would stay substantially constant within each time slot.

The manner in which buffer occupancy thresholds can be determined for the FIG. 8 algorithm will now be described in greater detail.

The FIG. 8 algorithm uses low and high watermark buffer occupancy thresholds θ_{L},θ_{H} respectively to determine when to maintain or to suspend data transfers. In addition, the algorithm uses a minimum buffer occupancy threshold θᵢ(k). This is the minimum buffer occupancy for user Uᵢ to be scheduled for dynamic prioritizing of data transfer with k users. It can be thought of having two components, one is a conventional buffer occupancy threshold BT and the other represents additional buffering associated with the FIG. 8 algorithm. The latter component is used because data transfers for a dynamically prioritized user may be spaced far apart, and more particularly, spaced k time intervals apart on the average and even more in the worst case. As noted above, buffer occupancy thresholds herein can be specified in terms of a number of time slots.

Let B_{S} (k) be the additional buffering component attributable to use of the FIG. 8 algorithm. We set B_{S}(k)=3k time slots and set θᵢ(k)=BT+B_{S}(k) time slots. We maintain θ_{L}=BT. In addition we set θ_{H} to BT+B_{S}(K)=BT+3K where K is a large value for k (e.g. K=40) such that it is highly unlikely for K users to be simultaneously streaming in a cell.

It can be shown that if the channel fading variations of the k users are independent then the probability that the next data transfer for user Uᵢ would be scheduled after n time intervals is at most e^{-n/k}. Thus, at n=B_{S}(k)=3k, this probability is less than 0.05.

Although user Uᵢ is only involved in data transfer once every k time intervals on average, when it is scheduled it is the only user among the k users doing the data transfer and hence gets k times more rate. In addition, since user Uᵢ is scheduled only at time intervals when its channel quality and hence data rate are above average its data transfer stays higher than it would be if all k users were allowed data transfer at all times. This suggests that the data transfer of user Uᵢ can fall behind its average data transfer by at most BT+B_{S}(k) time intervals, thus motivating the above-described threshold θᵢ(k)=BT+B_{S}(k).

As a more particular example, assume that there are k=10 users whose data transfers are being dynamically prioritized. Let the scheduling time slot length be t=10 seconds. Thus for user Uᵢ we have B_{S}(k)=3k=30 time intervals or a buffer of size 30*10=300 seconds or 5 minutes. Thus 5 minutes of additional buffer occupancy, beyond that required by the conventional buffer threshold BT, is needed for implementation of the FIG. 8 algorithm. The high buffer occupancy threshold θ_{H} in this example may be set at 20 minutes.

As indicated above, the FIG. 8 embodiment operates in discrete scheduling intervals or time slots where each time slot has at least two phases, including a measurement phase in which all user devices are allowed to perform unconstrained data transfer at the fastest possible rate, and a regulation phase that follows the measurement phase and in which only selected user devices, such as those with above average channel qualities and data rates, are allowed to perform data transfer. Other types of scheduling intervals, phases and prioritization techniques may be used in other embodiments.

The length of the measurement phase in the FIG. 8 embodiment should be selected to ensure that each user device crosses “TCP slow start” and is able to attain a steady rate while still ensuring that the measurement phase is as short as possible. For example, one possible implementation of such an embodiment could utilize 5 seconds of measurement phase followed by 15 seconds of regulation phase for a total time slot length of 20 seconds. Other values can of course be used.

Also, the number of users n selected out of a total of N_{U} users for data transfer in the regulation phase can be varied. Thus embodiments of the invention can opportunistically and dynamically select the best n<N_{U} users in every measurement phase and only allow data transfers to those n users in the regulation phase.

Again, the foregoing are merely examples of possible implementations of certain embodiments, and should not be construed as limiting in any way.

Embodiments of the invention can provide significant advantages relative to conventional techniques. For example, by giving priority to the user devices with the best channel quality in each scheduling interval, the content delivery system 102 with scheduler 200 implementing the FIG. 8 scheduling algorithm is able to transfer much more content to the device caches 110 compared to conventional streaming protocols.

The scheduler also quickly reacts to the changes in the network and user device conditions to dynamically update the set of user devices selected for data transfer. The dynamic nature of the radio link (e.g., due to shadow fading) ensures that a mobile user is not stuck in a poor state for long periods of time and hence that user gets picked for data transfer by the scheduler often enough to keep its device cache well stocked with data. The scheduler is therefore able to opportunistically deliver content to all users while making sure that the content is delivered at the highest possible rates thus resulting in very efficient utilization of network resources.

As mentioned above, embodiments of the present invention may be implemented at least in part in the form of one or more software programs that are stored in a memory or other computer-readable storage medium of a processing device of a communication network. As an example, components of content delivery system 102 such as scheduler 200, regulator 202 and monitor 204 may be implemented at least in part using one or more software programs.

Of course, numerous alternative arrangements of hardware, software or firmware in any combination may be utilized in implementing these and other system elements in accordance with the invention. For example, embodiments of the present invention may be implemented in one or more ASICS, FPGAs or other types of integrated circuit devices, in any combination. Such integrated circuit devices, as well as portions or combinations thereof, are examples of “circuitry” as the latter term is used herein.

It should again be emphasized that the embodiments described above are for purposes of illustration only, and should not be interpreted as limiting in any way. Other embodiments may use different types of communication networks, access networks, content delivery systems, server components, client components, schedulers, monitors, user devices, buffers and other network elements, depending on the needs of the particular application. Alternative embodiments may therefore utilize the techniques described herein in other contexts in which it is desirable to provide improved throughput for content delivery to multiple user devices in a communication network. Also, it should be understood that the particular assumptions made in the context of describing the illustrative embodiments should not be construed as requirements of the invention. The invention can be implemented in other embodiments in which these particular assumptions do not apply. These and numerous other alternative embodiments within the scope of the appended claims will be readily apparent to those skilled in the art.

What is claimed is:

1. A method comprising:
identifying a set of user devices to receive content in a scheduling interval;
initiating delivery of the content to the set of user devices at respective delivery rates for a first portion of the scheduling interval;
monitoring conditions associated with delivery of the content to the set of user devices; and
adjusting a delivery rate of at least one of the user devices in the set for a second portion of the scheduling interval based at least in part on the monitored conditions.

2. The method of claim 1 wherein the monitored conditions comprise a buffer occupancy and a channel quality for each of the user devices.

3. The method of claim 1 wherein the identifying, initiating, monitoring and adjusting are repeated for each of a plurality of additional scheduling intervals.

4. The method of claim 1 wherein the identifying, initiating, monitoring and adjusting are performed by at least one processing device comprising a processor coupled to a memory.

5. The method of claim 1 wherein identifying a set of user devices to receive content in a scheduling interval comprises at least one of:
identifying user devices having respective buffer occupancies at or below a low watermark threshold and including those user devices in the set;
identifying user devices having respective buffer occupancies at or above a high watermark threshold and excluding those user devices from the set; and
identifying user devices having respective buffer occupancies between the low watermark threshold and the high watermark threshold and including those user devices in the set.

6. The method of claim 1 wherein adjusting a delivery rate of at least one of the user devices in the set comprises:
identifying at least one of the user devices in the set as having an above average channel quality for the first portion of the scheduling interval based on the monitored conditions;
increasing the delivery rate in the second portion of the scheduling interval for said at least one user device identified as having an above average channel quality; and
decreasing the delivery rate in the second portion of the scheduling interval for one or more other user devices in the set that are not identified as having an above average channel quality.

7. The method of claim 1 wherein adjusting a delivery rate of at least one of the user devices in the set comprises increasing the delivery rate for a given user device to a delivery rate that will allow buffer occupancy of the given user device to reach a specified level within the second portion of the scheduling interval.

8. The method of claim 1 wherein the first portion of the scheduling interval comprises a measurement phase of the scheduling interval and the second portion of the scheduling interval comprises a regulation phase of the scheduling interval.

9. The method of claim 1 wherein initiating delivery of the content to the set of user devices comprises:
selecting particular network caches from which the content will be delivered to the set of user devices;
selecting particular network paths over which the content will be delivered from the selected network caches to the set of user devices; and
controlling delivery of the content to the user devices from the selected network caches over the selected network paths.

10. The method of claim 9 wherein said selecting of particular network caches and selecting of particular network paths is performed at least in part responsive to the monitored conditions.

11. The method of claim 9 wherein selecting particular network paths over which the content will be delivered from the selected network caches to the set of user devices further comprising selecting a plurality of network paths over which the content will be delivered to a given one of the user devices.

12. The method of claim 11 wherein the plurality of network paths over which the content will be delivered to the given user device comprises a first network path through a first access network and a second network path through a second access network different than the first access network.

13. The method of claim 12 wherein the first access network comprises a cellular access network and the second access network comprises a wireless local area network.

14. The method of claim 12 wherein selecting particular network paths over which the content will be delivered from the selected network caches to the set of user devices further comprises switching from a first one of the plurality of network paths to a second one of the plurality of network paths responsive to a change in at least one of the monitored conditions.

15. An article of manufacture comprising a computer-readable storage medium having embodied therein executable program code that when executed by a processing device causes the processing device to perform the method of claim 1.

16. An apparatus comprising:
a content delivery system comprising a processor coupled to a memory;
the content delivery system being configured to identify a set of user devices to receive content in a scheduling interval, to initiate delivery of the content to the set of user devices at respective delivery rates for a first portion of the scheduling interval, to monitor conditions associated with delivery of the content to the set of user devices, and to adjust a delivery rate of at least one of the user devices in the set for a second portion of the scheduling interval based at least in part on the monitored conditions.

17. The apparatus of claim 16 wherein the content delivery system comprises a network server component arranged between one or more network caches and an access point of an access network.

18. The apparatus of claim 16 wherein the content delivery system comprises a network server component configured to receive state information characterizing at least a portion of the monitored conditions from client components implemented in respective ones of the user devices.

19. The apparatus of claim 18 wherein the content delivery system is configured to adjust the delivery rate of said at least one user device for the second portion of the scheduling interval by providing a control signal to the client component implemented in that user device.

20. The apparatus of claim 16 wherein the content delivery system is further configured to select particular network caches from which the content will be delivered to the set of user devices, and to select particular network paths over which the content will be delivered from the selected network caches to the set of user devices.

21. An apparatus comprising:
a scheduler configured to identify a set of user devices to receive content in a scheduling interval and to initiate delivery of the content to the set of user devices at respective delivery rates for a first portion of the scheduling interval; and
a monitor coupled to the scheduler and configured to monitor conditions associated with delivery of the content to the set of user devices;
wherein a delivery rate of at least one of the user devices in the set is adjusted for a second portion of the scheduling interval based at least in part on the monitored conditions.

22. The apparatus of claim 21 wherein the adjustment of delivery rate is implemented in a regulator coupled to the scheduler and the monitor.

23. The apparatus of claim 21 further comprising:
a processor; and
a memory coupled to the processor;
wherein at least a portion of at least one of the scheduler and the monitor is implemented by the processor executing program code stored in the memory.
